(19) United States
(12) Patent Application Publication
(10) Pub. No.: US 2005/0242110 A1
(43) Pub. Date: Nov. 3, 2005

(54) Programmable fuel dispensing system

(76) Inventors: Eric S. Waugh, Las Vegas, NV (US); Jerry Nelson, Las Vegas, NV (US)

Correspondence Address: TROJAN LAW OFFICES, 9250 WILSHIRE BLVD, SUITE 325, BEVERLY HILLS, CA, 90212, US

(21) Appl. No.: 10/838,168

(22) Filed: May 3, 2004

(51) Int. Cl. B67D 5/06

(52) U.S. Cl. 222/71

(57) ABSTRACT

A centralized fuel or fuel monitoring, control and dispensing system operating under the control of a modern solid state programmable logic controller (PLC) that provides control options with capabilities far exceeding those available from relay logic systems. The system also incorporates compliance with the latest EPA mandates by accepting inputs from water and gasoline sensors that monitor the condition of the required “tank within a tank” dual storage tanks. If a fault condition is detected, the system will force a safety shutdown in the affected part of the installation. The PLC provides centralized monitoring, controlling and reporting functions to the operators of fuel dispensing operations such as self-service gas station complexes and fuel depots. Remote monitoring and programming of the PLC is provided by an internal modem through any available communications link.

### BACKGROUND OF THE INVENTION

1. Field of the Invention

This invention relates to fuel dispensing systems and more particularly relates to a programmable fuel dispensing system.

2. Background Information

Presently fuel dispensing systems at gas stations and other locales require a complex installation of circuits, relays, and contactors to control fuel dispensing plants. These electronic components are typically mounted in a separate control room on a wall. The relays, contactors, and circuits are to this day usually installed and mounted by an electrician often, in fact usually, without the benefit of an overall wiring diagram.

The sheer number of input and control relays result in a complex installation. Also while these contactors and relays are much more reliable than in the past, so many are required that servicing and repairs are required more frequently than is desirable. Further the lack of a reliable wiring diagram exacerbate the problems. So much so that the removal of relays and moving contactors would be advantageous.

It is therefore one object of the present invention to simplify the installation of a fuel dispensing system.

Another object of the present invention is to simplify a fuel dispensing system by reducing the number of relays or moving contactors in a system.

Yet another object of the present invention is to simplify a fuel dispensing system by eliminating substantially all relays and moving contactors in the system.

Still another object of the present invention is to simplify a fuel dispensing system by replacing relays and moving contactors with extremely reliable solid state devices.

Yet another object of the present invention is to simplify a fuel dispensing system by replacing relays, contactors, and control circuits with a solid state programmable logic controller.

Still another object of the present invention is to improve the reliability and simplify a fuel dispensing system by replacing relays, contactors, and control circuits with a programmable solid state logic controller that is programmable remotely.

Yet another object of the present invention is to improve the reliability and simplify a fuel dispensing system by replacing relays, contactors, and control circuits with a programmable solid state logic controller that is remotely programmable by use of a modem.

Still another object of the present invention is to provide a more efficient fuel dispensing system by replacing relays, contactors, and control circuits with a programmable logic controller that is programmable remotely through a modem that also includes control of other circuits at the fuel dispensing station.

Yet another object of the present invention is to improve the reliability and simplify fuel dispensing systems by replacing relays, contactors, and central circuits with a remotely programmable solid state logic controller that can also control station lighting.

Still another object of the present invention is to provide a more reliable fuel dispensing system by replacing relays, contactors, and central circuits with a remotely programmable solid state logic controller that can also monitor fuel tanks at a station.

### BRIEF DESCRIPTION OF THE INVENTION

The purpose of the present invention is to simplify and increase the reliability of fuel dispensing system by replacing relays, contactors, and central circuits with solid state devices such as a programmable logic controller (PLC) that also improves maintenance and simplifies the installation.

The fuel dispensing system of the present invention can be installed at a service station, mini-mart, or fuel depot. Typically, the system is installed in a secured, lockable equipment room out of sight of the public, but may also be in public areas as it is secured. The fuel dispensing system replaces an assortment of panel-boards, relays, contactors, and central circuits of present fuel dispensing systems installed by electricians without the benefit of a wiring diagram. Service calls are not only reduced but are also simplified by the present invention.

The system employs a solid state programmable logic controller (PLC) to replace many of the relays, contactors, and central circuits of a fuel dispensing system. Specifically, input and central relay logic are eliminated leaving only contactors to turn off fuel dispensers or pumps except where a system lockout relay shuts the system down in case of malfunctions in fuel tanks or tank containers. All power distribution components, panel boards, contactors, etc. are combined in one cabinet with all connections terminated on terminal blocks. The replacement of relays and contactors with a solid state programmable logic controller is fully compatible with existing fuel dispensing control systems and requires less space presenting a much neater appearance.

The programmable logic controller is preferably an Allen Bradley Model 1762L40AWA or its equivalent. Logic inputs turn on a logic output which turns on a selected fuel pump usually through a single relay to pump fuel. Removal of a logic input stops fuel pumping by turning off the pump relay.

The system also monitors fuel tanks or fuel containment tanks. Typically a leak in a fuel tank or fuel containment tank will result in an input to the logic circuit that prevents any outputs to stop fuel dispensers from being operated until the problem has been located and repaired. This leak may be fuel leaking from the tank or water leaking into the tank. This optional feature is unique to the fuel dispensing system of the invention. Once the problem is resolved, the system can be reset and put back in service to continue normal operation.

The programmable logic controller can also be used to control other features at a pumping station such as lighting and signs. Outputs from either a photocell or a time switch to the programmable logic controller will control the station lighting and signs on and off times.

The novel fluid dispensing system of the present invention simplifies and improves the reliability of fuel dispensing particularly at self-service stations. It is comprised of a central control panel produced, debugged, and optimized at a factory location, then installed in the field and connected to existing station equipment. This method greatly simplifies the task of field installation when compared to the conventional practice of building a relay logic design on site with or without design drawings and assembly sketches that are difficult at best to implement and then try to make it work. The overall design is similar to embedded computer control systems that use a central processor interfaced to local inputs and outputs.

The “brains” of the system is a modem programmable logic controller (PLC) or microprocessor that is programmable externally and monitored via a modem over any available communications link. This arrangement provides an opportunity for third party oversight and control of self-service gas station complexes and fuel depots as a service but can also serve the owner/operator. The PLC replaces a plurality of relays with solid state reliability. While electromechanical relays have a very long average life expectancy solid state logic has no known wearout mechanism such as electromechanical relay contact wear and can be expected to operate reliably for many years. Use of many electromechanical relays almost assures that some will fail well before their maximum life expectancy.

The PLC is programmed to essentially automate the operation of a self-service gas station. It enables the fuel dispensing pumps upon validation, it turns on the station lights and signs at dusk, it monitors the safe condition of the fuel storage tanks. It accepts program changes from remote input via modem and reports operating conditions for off-site monitoring and control. In a current embodiment of the invention, the PLC function is implemented by a commercially produced industrial controller such as a Allen Bradley Model 1762L40 AWA, a GE/Fanuc UAA007 or their equivalent mounted in a compact wall mounted enclosure and connected to an array of interface contactors, relays and terminal strips that facilitate rapid and accurate connection to existing station equipment. Support equipment for the controller such as battery back-up and power conditioning is also provided.

The above and other objects, advantages, and novel features of the invention will be more fully understood from the following detailed description and the accompanying drawings, in which:

### BRIEF DESCRIPTION OF THE DRAWINGS

FIG. 1 is a schematic block diagram illustrating the programmable solid state fuel dispensing control system according to the invention.

### DETAILED DESCRIPTION OF THE INVENTION

A schematic block diagram of the programmable solid state fuel dispensing control system according to the invention is illustrated. The system includes a fuel station electronically enhanced control panels. It is an advancement over the electro-mechanical style of equipment typically implemented in conventional present day fuel dispensing systems. The new re-designed system eliminates the all “hard contact” style of numerous relays used to interface with the fueling system, lighting control system, and cash registers.

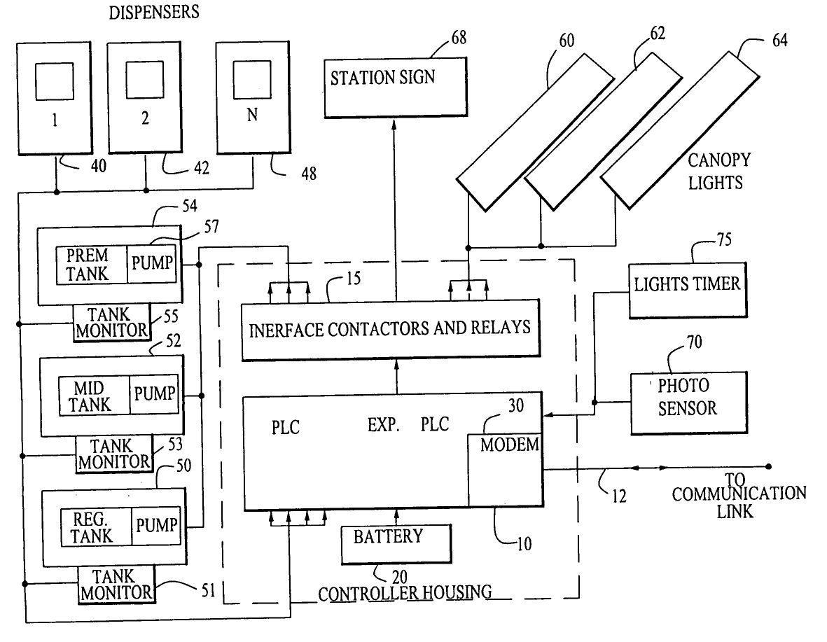

Referring to the schematic block diagram of FIG. 1, a novel system is shown in which substantially all hard contacts have been replaced by incorporating a state of the art programmable logic controller (PLC) 10. This solid state device is programmed to receive various inputs and provide outputs that energize the appropriate contactor to turn on dispensers 40, 42, 48, lighting 60, 62, 64, 68, etc. at the appropriate time. An internal clock in the PLC is incorporated as well as internal backup battery 20 to insure that outages do not disrupt the clock or the programming. An internal modem incorporated into the system permits remote diagnostics or program changes at any time.

The typical installation and arrangement illustrated in FIG. 1 includes PLC 10 where function is implemented preferably with a GE/Fanuc Model UAA007 industrial controller or an Allen Bradley 1762L40AWA or their equivalents. Additional PLC's may be added as needed for large plants. External programming of PLC 10 is facilitated via an internal modem 30 that can interchange information over any available communications link 12 such as a telephone line or an RF link with a remote computer or dedicated terminal.

PLC 10 is programmed to operate various components of existing fuel station equipment by engaging interface relays or contactors 15 that have current ratings sufficient for the various loads. The sequence of relay and contactor operations is determined by PLC 10 programming in response to inputs from a variety of sensors 51, 53, 55 and contact closures 15 throughout the station.

For example when dispenser 40 is activated by a customer lifting a dispensing nozzle from its cradle and choosing a grade of fuel (e.g., premium), contact closure 15 sends a signal to PLC 10 to turn on pump 57 connected to premium tank 54. Pumping will proceed unless fault detecting tank sensor 55 has not sent a signal indicating there is a fault condition. If a leak, either water leaking into the tank or fuel leaking out, has previously occurred in premium tank 54, fault detecting sensor 55 sends a signal that causes PLC 10 to prohibit dispensing of fuel from premium tank 54. This will only impede dispensing premium grade fuel from premium tank 54 but will not interfere with the availability or dispensing of other grades of fuel from other tanks 50 and 52 which will keep the functioning parts of the station in operation. Further once the problem has been corrected (i.e., leak repaired) fault detecting sensor 55 will be reset bringing premium grade tank 54 back on line.

PLC 10 also performs a number of housekeeping chores in addition to monitoring, reporting, and operating fuel dispensing equipment. These chores are performed by connecting station canopy lights 60, 62, and 64 and perhaps sign lights 68 to PLC 10 through interface contactors 15 programmed to control these functions. PLC 10 will receive signals from either a photo sensor 70 and/or a timer 75. Sensor 70 would provide an input to PLC 10 at dusk to operate station canopy lights 60, 62, and 64 and perhaps sign lights 68.

Alternately timer 75 could be used alone or in conjunction with photo sensor 70 to control lights at a specific time. For example timer 75 could turn all lights on at a specific time while photo sensor 70 would turn them off at sunrise or vice versa. To preserve the integrity of the local clock and PLC 10 program backup battery 20 is provided that has sufficient capacity to ride out even extended power failures.

Thus there has been disclosed a novel and unique programmable solid state fuel dispensing system that can be used not only in gas stations but also in a wide variety of industrial processing plants. The system can be tailored to monitor, control and report on performance by an appropriately configured program.

This invention is not to be limited by the embodiment shown in the drawings and described in the description which is given by way of example and not of limitation, but only in accordance with the scope of the appended claims.

1. A solid state programmable fuel dispensing and control system comprising;
at least one fuel tank;
at least one fuel dispenser connected to said fuel tank;
at least one contactor for activating pumping of fuel to said at least one fuel dispenser;
a solid state programmable logic controller connected to said at least one contactor programmed to activate said at least one contactor when a signal is received from a fuel dispenser.

2. The system according to claim 1 in which said at least one fuel tank comprises a plurality of fuel tanks to provide multiple grades of fuel.

3. The system according to claim 2 including fault sensors connected to each of said plurality of tanks, said fault sensors transmitting a signal to said programmable logic controller to prohibit operation of said at least one contactor if a fault condition is detected.

4. The system according to claim 3 in which said fault sensor detects fuel leakage and sends a signal to prohibit dispensing of fuel.

5. The system according to claim 3 in which said fault sensor detects water leaking into said fuel tank and sends a signal to said programmable logic controller to prohibit dispensing of fuel.

6. The system according to claim 5 in which each of said plurality of tanks has a fault sensor.

7. The system according to claim 4 in which each of said plurality of tanks has a fault sensor.

8. The system according to claim 1 in which said programmable logic controller is programmed to control lights at a fuel station.

9. The system according to claim 8 in which a photo sensor is connected to said programmable logic controller, said photo sensor sending a signal to said programmable logic controller to turn lights on at dusk.

10. The system according to claim 8 including a timer to control lights at a fuel station, said timer being connected to said programmable logic controller to turn lights on and off at specified times.

11. The system according to claim 8 including a photo sensor and a timer, said photo sensor and timer working in conjunction with each other to turn fuel station lights on and off.

12. The system according to claim 3 including a separate fault sensor associated with each fuel tank.
